(19) United States
(12) Patent Application Publication
(10) Pub. No.: US 2002/0030171 A1
(43) Pub. Date: Mar. 14, 2002

(54) Opening/closing valve

(76) Inventors: Tsuneo Ishigaki, Saitama-ken (JP); Toyonobu Sakurai, Yokohama-shi (JP); Akira Enzaki, Iwai-shi (JP)

Correspondence Address: PAUL A. GUSS, PAUL A. GUSS ATTORNEY AT LAW, 775 S 23RD ST FIRST FLOOR SUITE 2, ARLINGTON, VA, 22202

(21) Appl. No.: 09/948,630

(22) Filed: Sep. 10, 2001

(30) Foreign Application Priority Data
Sep. 11, 2000 (JP) 2000-274899

(51) Int. Cl. F16K 31/00

(52) U.S. Cl. 251/291

(57) ABSTRACT

An opening/closing valve has an attachment/detachment mechanism for detachably interconnecting a valve body and a bonnet. The attachment/detachment mechanism comprises a first annular groove provided at a connecting recess of the valve body, a second annular groove provided at a connecting projection of the bonnet, and an elastic semiannular member. The elastic semiannular member is installed to the first annular groove and the second annular groove respectively when the valve body and the bonnet are interconnected.

### BACKGROUND OF THE INVENTION

1. Field of the Invention

The present invention relates to an opening/closing valve which makes it possible to open/close, for example, a passage for a fluid such as a pressure fluid and a gas, or a discharge passage.

2. Description of the Related Art

Conventionally, a pump and various processing chambers have been connected one another via passages of piping tubes and valves in a machine for producing semiconductor products such as semiconductor wafers and liquid crystal substrates. Operation of opening/closing the passage is controlled under the energizing/deenergizing action of the valve.

The machine for producing semiconductor products needs to reduce the maintenance time as short as possible because of the expensive production cost and the depreciation expense per unit time. If troubles occur in the machine for producing semiconductor products, it is necessary to exchange internal parts (a bonnet, a seal member or the like) with the piping tube being connected to the valve.

A conventional opening/closing valve 1 suggested by the present applicant is shown in FIG. 9. When the opening/closing valve 1 is disassembled by detaching a bonnet 3 from a body 2, four bolts 4 integrally connecting the body 2 and the bonnet 3 are loosened and detached with an unillustrated tool of an exclusive use. Subsequently, the bonnet 3 is separated from the body 2 to perform the maintenance operation or the operation for exchanging the part.

With the above conventional opening/closing valve, however, it is necessary to prepare the tool of an exclusive use to detach the plurality of bolts which integrally connect the body and the bonnet. Further, a long period of time is required to perform the operation for detaching the bolts in a small and narrow space depending upon the environment where the opening/closing valve is installed.

It is difficult to shorten the time required for the maintenance operation since the operation for detaching the bolts is performed in the small and narrow space with the tool of an exclusive use.

### SUMMARY OF THE INVENTION

It is a general object of the present invention to provide an opening/closing valve which makes it possible to shorten the time required for the maintenance operation without using any tool of an exclusive use, by providing an attachment/detachment mechanism for easily attaching/detaching a valve body and a bonnet.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 shows a vertical sectional view taken along an axial direction of an opening/closing valve according to an embodiment of the present invention;

FIG. 2 shows a magnified vertical sectional view illustrating an attachment/detachment mechanism for constructing the opening/closing valve;

FIG. 3 shows a magnified vertical sectional view illustrating a state in which a bonnet is lifted upwardly starting from a state shown in FIG. 2 in which a valve body and the bonnet are interconnected to one another;

FIG. 4 shows a plan view illustrating an installing state and a free state of an elastic semiannular member for constructing the attachment/detachment mechanism;

FIG. 5 shows a lateral sectional view taken along a line V-V shown in FIG. 1;

FIG. 6 shows, with partial cutaway, a perspective view illustrating a seal member to be installed to a connecting site between the body and the bonnet;

FIG. 7 shows a vertical sectional view illustrating the sealing function of the seal member;

FIG. 8 shows a vertical sectional view illustrating a state in which the bonnet is removed from the valve body by the attachment/detachment mechanism; and

FIG. 9 shows an exploded perspective view illustrating a conventional opening/closing valve suggested by the present applicant.

### DESCRIPTION OF THE PREFERRED EMBODIMENTS

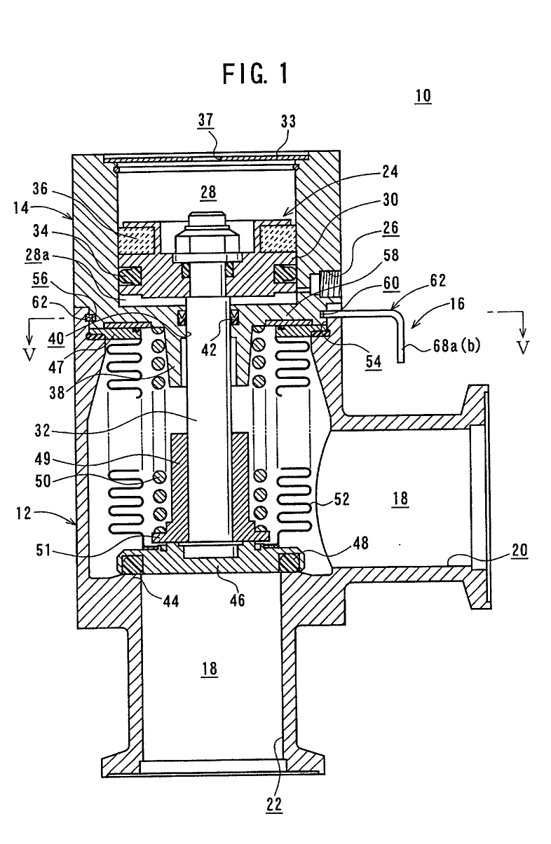

In FIG. 1, reference numeral 10 indicates an opening/closing valve according to an embodiment of the present invention.

The opening/closing valve 10 includes a valve body 12 of a substantially angular barrel shape, a bonnet 14 independent of the valve body 12 and connected to an upper portion of the valve body 12, and an attachment/detachment mechanism 16 disposed between the valve body 12 and the bonnet 14 and detachably interconnecting the valve body 12 and the bonnet 14.

A chamber 18 is formed in the valve body 12. A first port 20 and a second port 22 are provided for the chamber 18 in directions perpendicular with each other so that the first port 20 and the second port 22 may communicate one another.

A cylinder mechanism 24 functioning as a driving mechanism is disposed in the bonnet 14. The cylinder mechanism 24 includes a piston 30 slidably displaceable along a cylinder chamber 28 under the action of a pressure fluid supplied from a pressure fluid supply port 26, a piston rod (valve rod) 32 connected to the piston 30, and a cover member 33 closing the cylinder chamber 28.

A piston packing 34 is installed to an annular groove of the outer circumferential surface of the piston 30. A ring-shaped magnet 36 is installed to an annular groove disposed at a position close to the piston packing 34. A ventilation hole 37 communicating with the atmospheric air is formed through a substantial center of a cover member 33.

A bearing section 38 axially supporting the piston rod 32 is formed at a lower portion of the bonnet 14. The bearing section 38 has a shaft hole 40 through which the piston rod 32 is inserted, and a rod packing 42 installed to the inner circumferential surface of the shaft hole 40 surrounding the outer circumferential surface of the piston rod 32.

A valve disk 46 is connected to an end of the piston rod 32 facing the interior of the chamber 18 of the valve body 12 so that the communication between the first port 20 and the second port 22 may be blocked if the valve disk 46 is seated on an annular seat section 44 formed in the valve body 12. A seal ring 48, which effects the sealing function by contacting with the seat section 44, is installed to the valve disk 46 by an annular groove.

A spring member 50 is arranged in the chamber 18 of the valve body 12. The spring member 50 has an end fastened to a holder 47 as described later on and another end fastened to a flange 51 of a cylindrical member 49 for surrounding the piston rod 32. The valve disk 46 is urged to be seated onto the seat section 44 by the resilient force of the spring member 50.

A bellows 52 is arranged in the chamber 18 of the valve body 12. The bellows 52 has an end fastened to the holder 47 and another end fastened to an annular groove of the valve disk 46. The piston rod 32, the spring member 50 or the like are covered with the bellows 52.

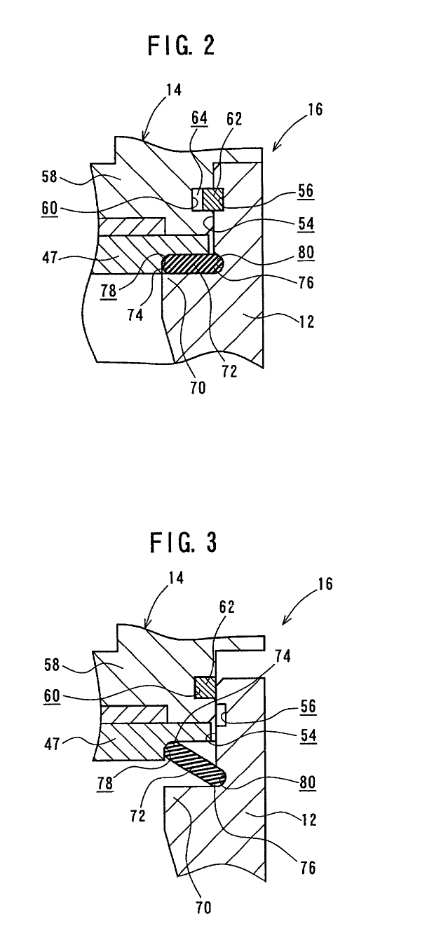

As shown in FIGS. 2 and 3, the attachment/detachment mechanism 16 includes a first annular groove 56 which is formed on the inner circumferential surface of a connecting recess (connecting section) 54 provided at an upper portion of the valve body 12, a second annular groove 60 which is formed on the outer circumferential surface of a connecting projection (connecting section) 58 provided at a lower portion of the bonnet 14, and an elastic semiannular member 62 which is installed to the first annular groove 56 and the second annular groove 60 respectively when the connecting projection 58 is inserted into the connecting recess 54 to interconnect the valve body 12 and the bonnet 14.

When the valve body 12 and the bonnet 14 are interconnected, the first annular groove 56 and the second annular groove 60 are mutually opposed. In this state, as shown in FIG. 2, a clearance 64 is formed on the second annular groove 60 to which the elastic semiannular member 62 is installed. The clearance 64 functions as a permission space when the diameter of the elastic semiannular member 62 is reduced.

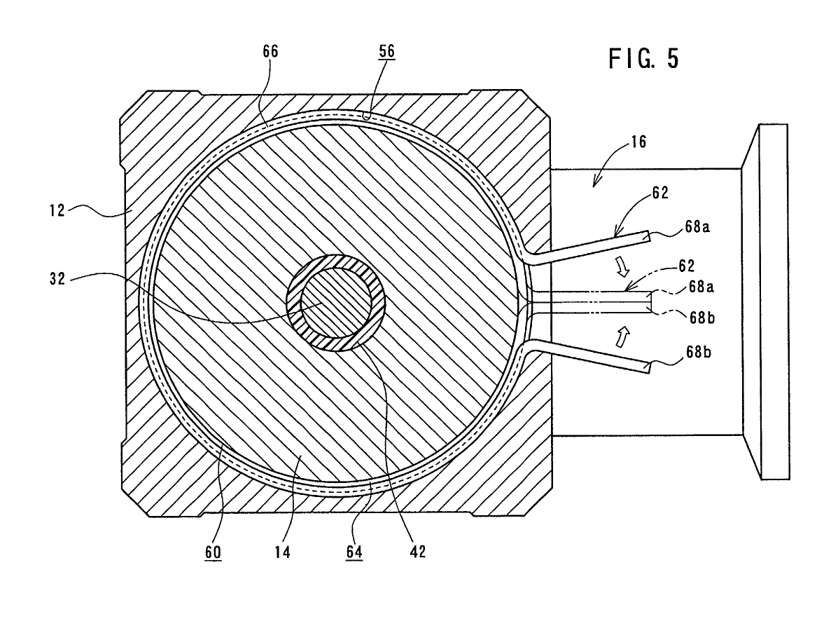

As shown in FIG. 5, the elastic semiannular member 62 comprises a band-shaped semiannular section 66 which is formed along the first and second annular grooves 56, 60, and a pair of grip sections 68a, 68b which are formed at both ends of the elastic semiannular member 62 and which are bent substantially perpendicularly.

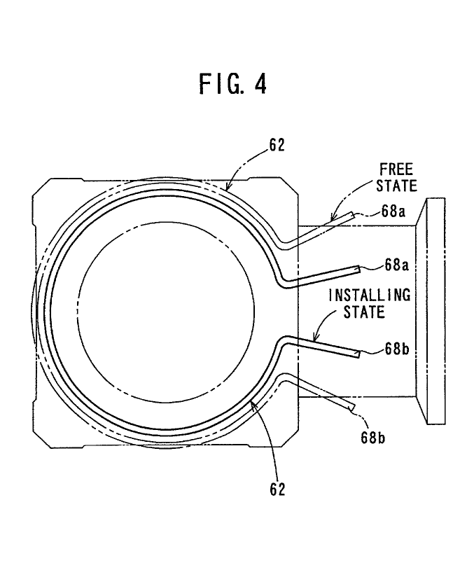

The spacing distance between the pair of grip sections 68a, 68b becomes maximum under the action of the elastic force of the elastic semiannular-member 62 if the elastic semiannular member 62 is in its free state (see two-dot chain line in FIG. 4). When the elastic semiannular member 62 is installed into the first and second annular grooves 56, 60 against the elastic force, the grip sections 68a, 68b are spaced one another by a predetermined length (see solid line in FIG. 4).

In this arrangement, when an operator grips the pair of grip sections 68a, 68b with fingers against the elastic force and the pair of grip sections 68a, 68b approach and abut one another, the diameter of the semiannular section 66 is reduced. Then, the elastic semiannular member 62 is separated from the first annular groove 56 of the valve body 12, and the diameter thereof is reduced along the second annular groove 60 of the bonnet 14. Therefore, the elastic semiannular member 62 is released from the valve body 12 to which the elastic semiannular member 62 is fastened. As a result, the bonnet 14 can be easily detached from the valve body 12.

An annular step section 70 is formed at the connecting recess 54 of the valve body 12. The annular holder 47 for holding the bellows 52 abuts against the annular step section 70. The holder 47 is formed separately from the bonnet 14 so that it may abut against the bonnet 14. A seal member 72 sealing the connecting site between the valve body 12 and the bonnet 14 is installed between the holder 47 and the annular step section 70 of the valve body 12.

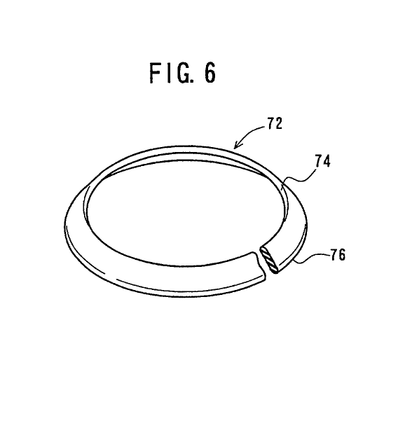

The seal member 72 is composed of an elastic material such as rubber or the like. As shown in FIG. 6, the seal member 72 is of a hollow and substantially truncated cone shape. The diameter of the seal member 72 gradually increases from an inner diameter section 74 having a small diameter to an outer diameter section 76 having a large diameter if the seal member 72 is in its free state. The inner diameter section 74 of the seal member 72 is engaged with a first seal-installing groove 78 having a curved cross section formed on the outer circumferential surface of the holder 47. The outer diameter section 76 is engaged with a second seal-installing groove 80 having a curved cross section formed on the annular step section 70 of the valve body 12 (see FIGS. 2 and 3).

The cross section of the seal member 72 is substantially elliptic depending upon the shapes of the first and second seal-installing grooves 78, 80 (see FIGS. 2, 3, and 6).

When the bonnet 14 is interconnected to the valve body 12, the inner diameter section 74 of the seal member 72 is pressed to form a substantially horizontal annular member.

Thereafter, the substantially horizontal annular member is compressed by the first seal-installing groove 78 of the holder 47 and the second seal-installing groove 80 of the valve body 12 to exhibit the sealing function.

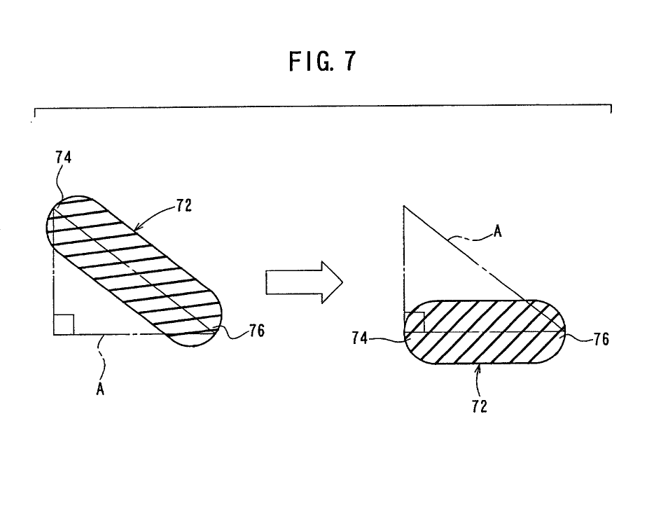

In other words, as shown in FIG. 7, the seal member 72 has its cross-sectional configuration which is formed along the hypotenuse of a right-angled triangle A if the seal member 72 is in its free state. When the bonnet 14 is interconnected to the valve body 12, the inner diameter section 74 is pressed and the cross-sectional configuration thereof is formed along the base of the right-angled triangle A.

Therefore, when the cross section of the seal member 72 forms the substantially flat annular member along the base of the right-angled triangle A, the seal member 72 is compressed in the substantially horizontal direction between the first seal-installing groove 78 and the second seal-installing groove 80 to effect the sealing function. As a result, even if the gap is generated at the connecting site between the valve body 12 and the bonnet 14 due to a production error or the like, the sealing function is reliably achieved by the seal member 72.

The seal member 72 is compressed in the substantially horizontal direction and does not undergo any excessive compressive force in the installing direction (substantially in the vertical direction) unlike a known O-ring (not shown). Therefore, the bonnet 14 can be easily installed to the valve body 12.

Further, since the seal member 72 effects the sealing action with the inner diameter section 74 and the outer diameter section 76, the sealing performance of the seal member 72 is not greatly affected even if slight dimensional discrepancy occurs in the axial direction.

The preferable areal size of the substantially elliptic cross section of the seal member 72 is set to be about 85 % to 98 % of the entire area obtained by combining those of the first seal-installing groove 78 of the holder 47 and the second seal-installing groove 80 of the valve body 12 in the sealed state.

The opening/closing valve 10 according to the embodiment of the present invention is basically constructed as described above. Its operation, function, and effect will now be explained.

Tentatively as the initial position, as shown in FIG. 1, the piston 30 is at the lower limit position, the seal ring 48 of the valve disk 46 is seated on the seat section 44, and the communication between the first port 20 and the second port 22 is blocked.

The pressure fluid (for example, compressed air), which is supplied from the pressure fluid supply port 26 by energizing the unillustrated pressure fluid supply source, is introduced into the lower cylinder chamber 28a. The piston 30 is pressed upwardly under the action of the pressure fluid. In this situation, the piston 30 and the piston rod 32 are moved upwardly integrally. The valve disk 46 connected to the end of the piston rod 32 is separated from the seat section 44 against the resilient force of the spring member 50. The gap is formed between the valve disk 46 and the seat section 44, therefore communicating the first port 20 and the second port 22 one another via the gap.

When the pressure fluid supply port 26 is opened to communicate with the atmospheric air under the switching action of an unillustrated directional control valve, the piston 30, the piston rod 32, and the valve disk 46 are moved downwardly integrally under the action of the resilient force of the spring member 50. The seal ring 48 of the valve disk 46 is seated on the seat section 44 to give the initial state.

The passage (not shown), through which the first port 20 and the second port 22 make communication, can be opened/closed by displacing the valve disk 46 in cooperation with the piston 30 under the action of the pressure fluid supplied from the pressure fluid supply port 26 as described above.

Next, a case will be explained in which the bonnet 14 is detached from the valve body 12 to perform the maintenance operation with unillustrated tube passages being connected to the first port 20 and the second port 22 of the opening/closing valve 10 according to the embodiment of the present invention.

The operator grips the pair of grip sections 68a, 68b of the elastic semiannular member 62 with fingers against the resilient force so that the pair of grip sections 68a, 68b may approach and abut one another (see two-dot chain line in FIG. 5). When the pair of grip sections 68a, 68b having been spaced by a predetermined distance abut one another, the semiannular section 66 of the elastic semiannular member 62 is disengaged from the first annular groove 56 of the valve body 12, and the diameter of the semiannular section 66 of the elastic semiannular member 62 is reduced along the clearance 64 of the second annular groove 60 of the bonnet 14.

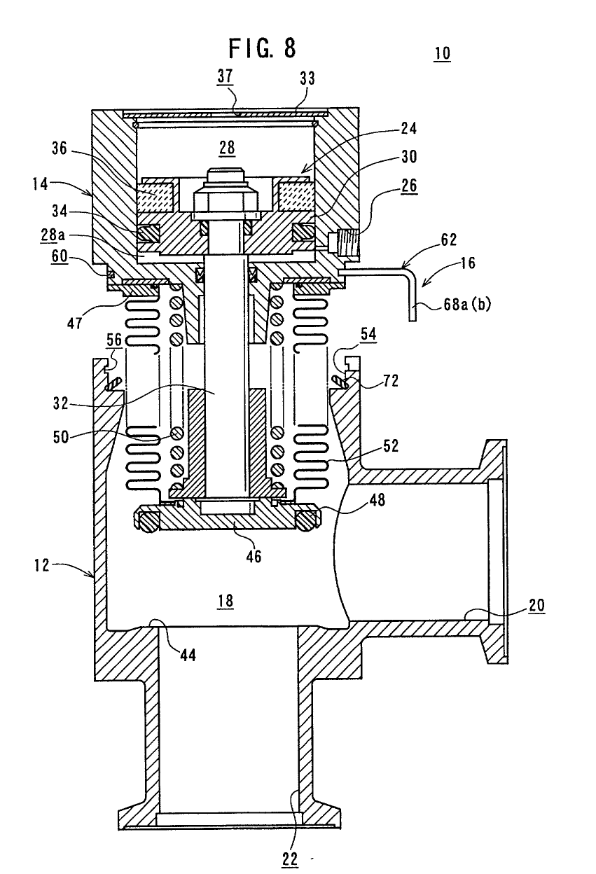

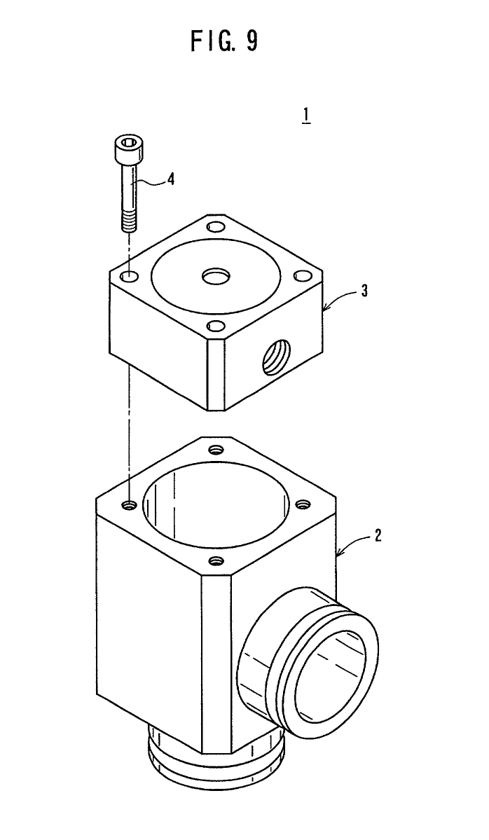

As shown in FIG. 2, while the valve body 12 and the bonnet 14 are interconnected in the above situation, the elastic semiannular member 62 having been installed to both of the first annular groove 56 and the second annular groove 60 is installed to only the second annular groove 60 of the bonnet 14 under the action of the reduction of diameter. Accordingly, the elastic semiannular member 62 is released from the valve body 12 to which it is installed (see FIG. 3). When the bonnet 14 is lifted upwardly with the elastic semiannular member 62 being released from the valve body 12 by gripping the pair of grip sections 68a, 68b, the bonnet 14 can be easily detached from the valve body 12 (see FIG. 8).

Conversely, when the bonnet 14 is installed to the valve body 12, the connecting projection 58 of the bonnet 14 is inserted into the connecting recess 54 of the valve body 12 with the diameter of the semiannular section 66 being reduced along the second annular groove 60 of the bonnet 14 by gripping the pair of grip sections 68a, 68b.

Thereafter, the first annular groove 56 and the second annular groove 60 are opposed one another. The diameter of the semiannular section 66 of the elastic semiannular member 62 is increased under the elastic action, and the semiannular section 66 is also installed to the first annular groove 56. Therefore, the elastic semiannular member 62 is installed to both of the first and second annular grooves 56, 60 respectively, and the valve body 12 and the bonnet 14 are fastened one another by the elastic semiannular member 62. Accordingly, the valve body 12 and the bonnet 14 are easily interconnected.

When the valve body 12 and the bonnet 14 are interconnected, the sealing function is exhibited as described above by the seal member 72 which is engaged with the first seal-installing groove 78 and the second seal 20 installing groove 80 respectively.

As described above, in the embodiment of the present invention, the bonnet 14 can be easily attached to/detached from the valve body 12 without using any tool of an exclusive use, by operating the attachment/detachment mechanism 16 having the elastic semiannular member 62. Therefore, even if the environment where the opening/closing valve 10 is installed is a narrow and small space, it is possible to shorten the operation time by easily performing the maintenance operation, the operation for exchanging parts or the like.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. An opening/closing valve comprising:
a driving mechanism;
a valve body having a first port and a second port for allowing a pressure fluid to flow therethrough;
a bonnet independent of said valve body and carried on said valve body;
a valve rod displaceable under a driving action of said driving mechanism;
a valve disk for opening/closing a communication passage between said first port and said second port formed in said valve body under the displacement action of the valve rod; and
an attachment/detachment mechanism disposed between said valve body and said bonnet, for detachably interconnecting said valve body and said bonnet,
wherein said attachment/detachment mechanism includes a first annular groove provided at a connecting section of said valve body, a second annular groove provided at a connecting section of said bonnet, and an elastic semiannular member to be installed to said first annular groove and said second annular groove respectively when said valve body and said bonnet are interconnected.

2. The opening/closing valve according to claim 1, wherein said elastic semiannular member comprises a semiannular section formed along said first and second annular grooves, and a pair of grip sections formed at both ends of said elastic semiannular member.

3. The opening/closing valve according to claim 1, wherein said second annular groove to which said elastic semiannular member is installed has a clearance for functioning as a permission space when a diameter of said elastic semiannular member is reduced.

4. The opening/closing valve according to claim 1, further comprising a seal member for sealing a connection site between said valve body and said bonnet, wherein said seal member is of a hollow and truncated cone shape and a diameter thereof gradually increases from an inner diameter section having a small diameter to an outer diameter section having a large diameter.

5. The opening/closing valve according to claim 4, wherein when said valve body and said bonnet are interconnected, said inner diameter section of said seal member is engaged with a first seal-installing groove having a curved cross section formed on an outer circumferential surface of a holder, while said outer diameter section is engaged with a second seal-installing groove having a curved cross section formed on an annular step section of said valve body.

6. The opening/closing valve according to claim 1, wherein said driving mechanism comprises a cylinder mechanism for displacing said piston under the action of said pressure fluid supplied to a cylinder chamber and said valve rod comprises a piston rod connected to said piston.
